(19) United States
(12) Patent Application Publication
(10) Pub. No.: US 2026/0012069 A1
(43) Pub. Date: Jan. 8, 2026

(54) STEPPER MOTOR

(71) Applicant: AAC Microtech (Changzhou) Co., Ltd., Changzhou City (CN)

(72) Inventors: Lubin Mao, Changzhou (CN); Wei Song, Changzhou (CN); Suntong Zhou, Changzhou (CN)

(21) Appl. No.: 18/986,727

(22) Filed: Dec. 19, 2024

Related U.S. Application Data
(63) Continuation of application No. PCT/CN2024/103194, filed on Jul. 2, 2024.

(51) Int. Cl. H02K 37/14; H02K 1/14; H02K 3/52; H02K 5/22; H02K 7/08

(52) U.S. Cl. CPC H02K 37/14; H02K 1/145; H02K 3/525; H02K 5/22; H02K 7/083; H02K 2211/03

(57) ABSTRACT

Provided a stepper motor, includes a shell, a stator assembly, and a stator assemblies. The rotor assembly includes a rotary shaft and a steel magnet. The stator assemblies are sleeved to the rotor assembly and arranged in an axial direction of the rotary shaft. Each stator assembly includes a housing, a fixation claw pole, and a winding. The housing includes a housing body fixed to the shell, and an inclined structure portion formed by localized depression of an outer periphery of the housing body toward the rotor assembly. A circuit board is affixed to the housing body, an orthographic projection of the circuit board toward the rotor assembly at least partially falls into a confine of the inclined structure portion, the inclined structure portion is provided with an avoidance hole, and a lead of the winding extends out via the avoidance hole and is electrically connected to the circuit board.

### CROSS REFERENCE TO RELATED APPLICATIONS

The present application is a continuation of PCT Patent Application No. PCT/CN2024/103194, filed Jul. 2, 2024, which is incorporated by reference herein in its entirety.

### TECHNICAL FIELD

The present disclosure relates to the technical field of motors and, in particular, to a stepper motor.

### BACKGROUND

The stepper motor has been widely used in the fields of electric motors, generators and the like due to its advantages of compact structure, high working efficiency, energy saving, etc. In recent years, there is an increasingly urgent demand in the industrial field for equipment that utilizes a stepper motor to directly drive loads for work, and the wide application of these stepper motor direct-drive equipment can bring great energy-saving benefits

In the existing art, most of the existing stepper motors are permanent magnet stepper motors of a claw pole type structure. The stepper motor includes a rotor, and a stator disposed around and spaced apart from the rotor, and the rotation of the stepper motor is realized by mutual driving of the stator and the rotor. The stator includes a housing, a claw-type magnetic pole fixed inside the housing, and a winding fixed around the claw-type magnetic pole. The rotor generally includes a rotary shaft, and a steel magnet fixed to an outer periphery of the rotary shaft. The claw-type magnetic pole is disposed around and spaced apart from the steel magnet, and the rotation of the stepper motor is realized by mutual driving of the steel magnet and the rotor and the winding.

However, the external shape of the existing housing is generally circular, and a lead of the winding is connected to an external circuit board by means of pin winding, which results in an increase in the width space of the product when stacked in the form of whole machine, occupying the overall space of the stepper motor, and thereby making the user experience poor.

Therefore, a novel stepper motor is desired to solve the above technical problems.

### SUMMARY

The present disclosure provides a stepper motor with a simple structure that saves the lead mounting space of the windings, thereby reducing the stacking width space of the whole machine.

To achieve the above objective, the present disclosure provides a stepper motor. The stepper motor includes a shell, a rotor assembly supported on and rotationally connected to the shell, and a plurality of stator assemblies fixed to the shell and disposed around and spaced apart from the rotor assembly. The rotor assembly includes a rotary shaft, and a steel magnet sleeved and fixed to the rotary shaft, an end of the rotary shaft being rotationally connected to the shell. The plurality of stator assemblies are sleeved to the rotor assembly and arranged in an axial direction of the rotary shaft, and each respective stator assembly of the plurality of stator assemblies includes a housing, a fixation claw pole, and a winding sleeved to the fixation claw pole. The housing is coaxially disposed with and fixed to the shell, and the housing includes a housing body fixed to the shell, and an inclined structure portion formed by localized depression of an outer periphery of the housing body toward the rotor assembly. The fixation claw pole is disposed around an outer periphery of the rotor assembly, and received and fixed in the housing. The stepper motor further includes a circuit board affixed to the housing body on a side of the housing body facing away from the rotor assembly, an orthographic projection of the circuit board toward the rotor assembly at least partially falls into a confine of the inclined structure portion, the inclined structure portion is provided with an avoidance hole, and a lead of the winding extends out via the avoidance hole and is electrically connected to the circuit board.

As an improvement, the circuit board includes a circuit board body, and a pad portion formed by bending and extending at least one side of the circuit board body, where the circuit board body is affixed to the housing, and an orthographic projection of the pad portion toward the rotor assembly at least partially falls into the confine of the inclined structure portion.

As an improvement, the housing includes a housing bottom fixed to the shell, and a housing sidewall bending and extending from an outer periphery of the housing bottom. The housing bottom includes an arcuate side, two parallel sides extending from two ends of the arcuate side respectively, a first straight side positioned opposite to the arcuate side and spaced apart from the two the parallel sides, and a second straight side and a third straight side bending and extending from two ends of the first straight side to the two parallel sides respectively. The housing sidewall includes a first arcuate sidewall extending from the arcuate side in the axial direction of the rotary shaft, two parallel sidewalls extending from the two parallel sides in the axial direction of the rotary shaft, and a first sidewall, a second sidewall and a third sidewall extending from the first straight side, the second straight side and the third straight side in the axial direction of the rotary shaft respectively. The circuit board body is affixed to the first sidewall, and the second sidewall and the third sidewall serve as two inclined structure portions.

As an improvement, the lead of the winding is fixed to the pad portion by gluing on a side of the pad portion facing away the rotor assembly.

As an improvement, the fixation claw pole includes a first law pole and a second law pole fixed opposite to each other in the housing and cooperating with each other, and the winding is sleeved and fixed to the first law pole and the second law pole.

As an improvement, the stepper motor further includes a magnetic isolation spacer, where the magnetic isolation spacer is of an annular structure, and sleeved and fixed to the fixation claw pole, and the winding is sleeved and fixed to the magnetic isolation spacer.

As an improvement, the stepper motor further includes two gaskets spaced apart from each other, where the two gaskets are sleeved to the rotary shaft, and fixed at two ends of the steel magnet respectively.

As an improvement, the shell includes a first cover plate and a second cover plate disposed opposite to each other, the first cover plate and the second cover plate are fixed to respective two ends of housings of respective two stator assemblies of the plurality of stator assemblies, and two ends of the rotary shaft are rotationally connected to the first cover plate and the second cover plate respectively.

As an improvement, the stepper motor further includes a first bearing and a second bearing. The first bearing is sleeved to an end of the rotary shaft adjacent to the first cover plate and embedded into and fixed to the first cover plate. The second bearing is sleeved to an end of the rotary shaft adjacent to the second cover plate, and embedded into and fixed to the second cover plate.

Compared with the existing art, in the stepper motor of the present disclosure, the stator assemblies are disposed around and spaced apart from the rotor assembly; the rotor assembly includes a rotary shaft, and a steel magnet sleeved and fixed to the rotary shaft, an end of the rotary shaft being rotationally connected to the shell; the plurality of stator assemblies are sleeved to the rotor assembly and arranged in an axial direction of the rotary shaft; and each stator assembly includes a housing coaxially disposed with and fixed to the shell, a fixation claw pole disposed around an outer periphery of the rotor assembly and received and fixed in the housing, and a winding sleeved to the fixation claw pole; the housing includes a housing body fixed to the shell, and an inclined structure portion formed by localized depression of an outer periphery of the housing body toward the rotor assembly; and the circuit board is affixed to the housing body on a side of the housing body facing away from the rotor assembly, an orthographic projection of the circuit board toward the rotor assembly at least partially falls into a confine of the inclined structure portion, the inclined structure portion is provided with an avoidance hole, and a lead of the winding extends out via the avoidance hole and is electrically connected to the circuit board. This facilitates direct attachment and fixation of the circuit board to the housing, and at the same time, saves the mounting space between the lead of the winding and the circuit board, reduces the width space of the stepper motor when stacked in the form of whole machine and facilitates miniaturized design.

### BRIEF DESCRIPTION OF THE DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other accompanying drawings from these accompanying drawings without creative efforts.

FIG. 1 is a perspective view of a stepper motor according to the present disclosure.

FIG. 2 is an exposed view of a part of the structure of a stepper motor according to an embodiment of the present disclosure.

FIG. 3 is a sectional view taken along line A-A of FIG. 1.

FIG. 4 is a sectional view taken along line B-B of FIG. 1.

FIG. 5 is a structure view illustrating a housing according to an embodiment of the present disclosure.

### DETAILED DESCRIPTION OF THE EMBODIMENTS

The technical solutions in the embodiments of the present disclosure are described in detail clearly and completely hereinafter with reference to the accompanying drawings. Apparently, the described embodiments are only a part, but not all, of the embodiments of the present disclosure. Based on the embodiments of the present disclosure, all other embodiments obtained by a person of ordinary skill in the art without creative efforts fall within the scope of protection of the present disclosure.

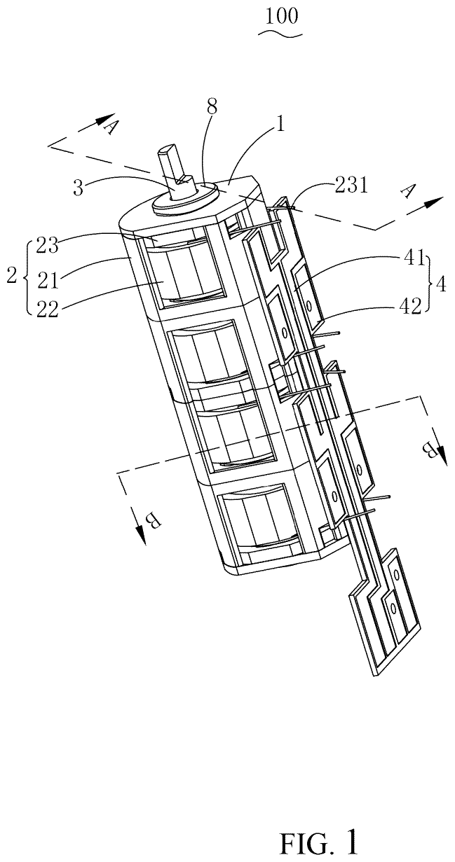

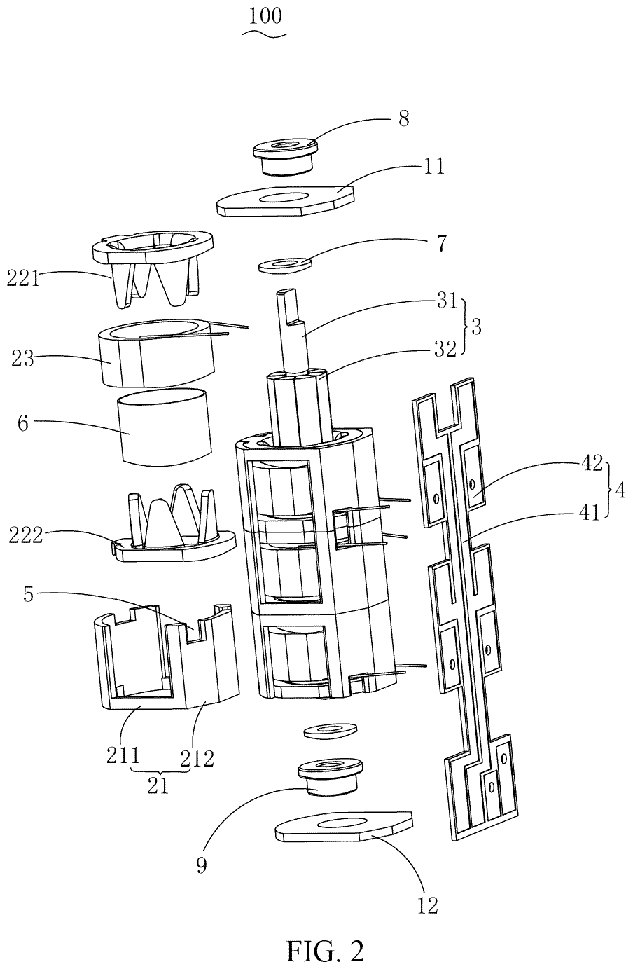

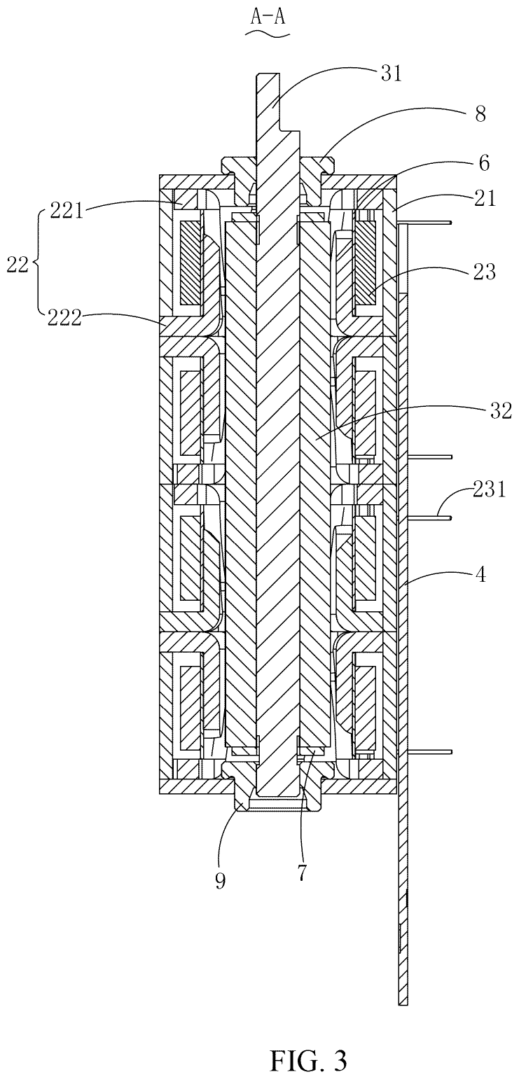

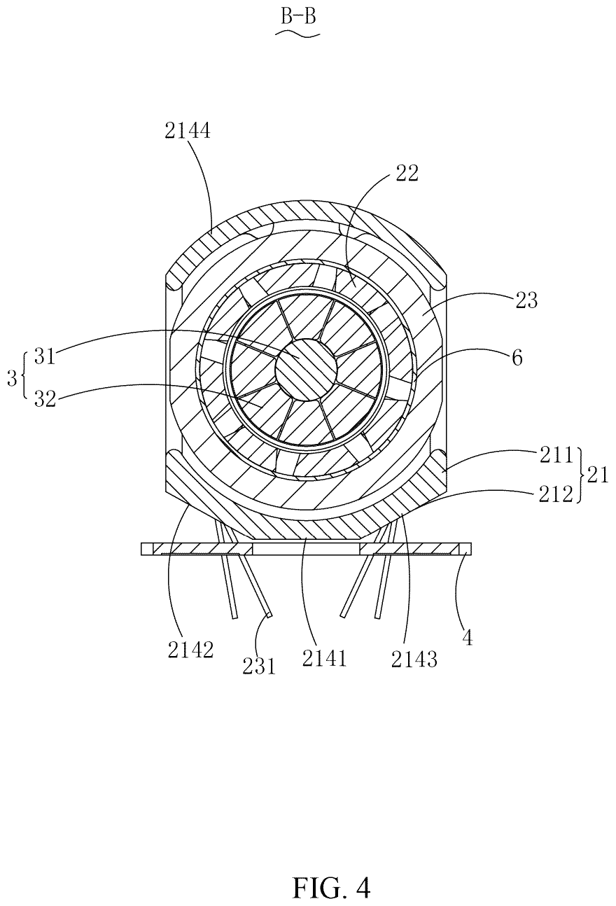

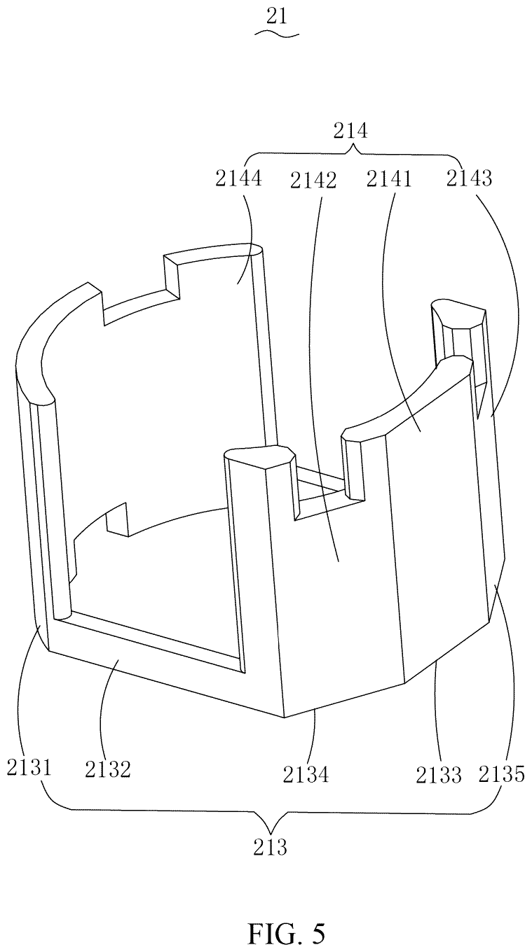

As shown in conjunction with FIGS. 1 to 5, an embodiment of the present disclosure provides a stepper motor 100. The stepper motor 100 includes a shell 1, a stator assembly 2, and a rotor assembly 3. The stator assembly 2 is fixed to the shell 1. The stator assembly 3 is supported on and rotationally connected to the shell 1. The stator assembly 2 is disposed around and spaced apart from the rotor assembly 3. By mutual driving of the stator assembly 2 and the rotor assembly 3, the rotor assembly 3 is driven to rotate on the shell 1, thereby achieving the rotation of the motor.

The rotor assembly 3 includes a rotary shaft 31, and a steel magnet 32 sleeved and fixed to the rotary shaft 31, where an end of the rotary shaft 31 is rotationally connected to the shell 1.

In some embodiments, the steel magnet 32 includes a plurality of magnetic pole structures arranged in a circumferential direction of the rotary shaft 31. The plurality of magnetic pole structures have the same polarity, or are provided with staggered opposite polarities.

A plurality of stator assemblies 2 are provided, and fixed to the shell 1. The plurality of stator assemblies 2 are sleeved to the rotor assembly 3 and arranged in an axial direction of the rotary shaft 31. Each stator assembly 2 includes a housing 21, a fixation claw pole 22, and a winding 23. The housing 21 is coaxially disposed with and fixed to the shell 1. The fixation claw pole 22 is disposed around an outer periphery of the rotor assembly 3. The winding 23 is sleeved to the fixation claw pole 22. The fixation claw pole 22 is received and fixed in the housing 21. The housing 21 includes a housing body 211 fixed to the shell 1, and an inclined structure portion 212 formed by localized depression of an outer periphery of the housing body 211 toward the rotor assembly 3. The inclined structure portion 212 designed in the localized area of the housing 21 does not affect the strength and the internal magnetic circuit space of the housing 21.

The stepper motor 100 further includes a circuit board 4. The circuit board 4 is affixed to the housing body 211 on a side of the housing body 211 away from the rotor assembly 3, and an orthographic projection of the circuit board 4 toward the rotor assembly 3 at least partially falls into a confine of the inclined structure portion 212. The inclined structure portion 212 is provided with an avoidance hole 5, and a lead 231 of the winding 23 extends out via the avoidance hole 5 and is electrically connected to the circuit board 4. The avoidance hole 5 facilitates the lead-out of the lead 231 of the winding 23 to be electrically connected to the circuit board 4, saving installation space. The circuit board 4 is directly affixed the housing 21, which is convenient for assembling, and at the same time, saves the installation space between the lead 231 of the winding 23 and the circuit board 4, reducing the width space of the stepper motor 100 when stacked in the form of whole machine and facilitating the miniaturization design.

In this embodiment, the circuit board 4 includes a circuit board body 41, and a pad portion 42 formed by bending and extending at least one side of the circuit board body 41. The circuit board body 41 is affixed to the housing 21, and an orthographic projection of the pad portion 32 toward the rotor assembly 3 at least partially falls into the confine of the inclined structure portion 212. One side of the circuit board 4 is bent to form the pad portion 42 so that affixation to different locations of the housing 21 is facilitated, making the assembly convenient.

In some embodiments, the circuit board 4 is a flexible printed circuit (FPC). The flexible structure makes the assembly convenient.

In some embodiments, the pad portion 42 is formed by extending from opposite sides of the circuit board body 41 toward the rotor assembly 3, further increasing the affixation area between the pad portion 42 and the housing 21 and improving the fixing effect of the circuit board 4 with the housing 21.

In some embodiments, the housing 21 includes a housing bottom 213 fixed to the shell 1, and a housing sidewall 214 bending and extending from an outer periphery of the housing bottom 213. The housing bottom 123 includes an arcuate side 2131, two parallel sides 2132, a first straight side 2133, a second straight side 2134, and a third straight side 2135. The two parallel sides 2132 extends from two ends of the arcuate side respectively. The first straight side 2133 is positioned opposite to the arcuate side 2131 and spaced apart from the two the parallel sides 2132. The second straight side 2134 and the third straight side 2135 bends and extends from two ends of the first straight side 2133 to the two parallel sides 2132 respectively. The housing sidewall 214 includes a first arcuate sidewall 2144, two parallel sidewalls, a first sidewall 2141, a second sidewall 2142, and a third sidewall 2143. The first arcuate sidewall 2144 extends from the arcuate side 2131 in the axial direction of the rotary shaft 31. The two parallel sidewalls extends from the two parallel sides 2132 in the axial direction of the rotary shaft 31. The first sidewall 2141, the second sidewall 2142 and the third sidewall 2143 extend from the first straight side 2133, the second straight side 2134 and the third straight side 2135 respectively in the axial direction of the rotary shaft 31. The circuit board body is affixed to the first sidewall 2141, and the second sidewall 2142 and the third sidewall 2143 serve as two inclined structure portions.

In some embodiments, the lead 231 of the winding 23 is fixedly connected to the circuit board 4 by gluing on a side of the pad portion 42 facing away from the rotor assembly 3. The pad portion 42 is affixed to the position of the inclined structure portion 212 so that both the welding and the gluing of the lead 231 of the winding 23 are made at that position, improving the fixing effect of the lead 231 and the circuit board 4, and by gluing the lead 231 to the pad portion 42 of the circuit board 4, the lead 231 is sealed. In this way, by adjusting the lead-out position at the inclined position of the housing 21, the processes of lead-out, welding, glue sealing and the like do not increase the width dimension of the product, thus further reducing the space limitation of the application.

In some embodiments, the fixation claw pole 22 includes a first law pole 221 and a second law pole 222 fixed opposite to each other in the housing 21 and cooperating with each other, and the winding 23 is sleeved and fixed to the first law pole 221 and the second law pole 222. The cooperating of the first claw pole 221 and the second claw pole 222 facilitates assembly.

In some embodiments, the stepper motor 100 further includes a magnetic isolation spacer 6. The magnetic isolation spacer 6 is of an annular structure, and sleeved and fixed to the fixation claw pole 22, and the winding 23 is sleeved and fixed to the magnetic isolation spacer 6. Such configuration facilitates the reduction of magnetic interference between the winding 23 and the claw pole 22, improves the mutual driving performance of the winding 23 and the steel magnet 32, and further improves the rotational performance of the stepper motor 100. The rotational performance of the stepper motor 100 is further improved.

In some embodiments, the stepper motor 100 further includes two gaskets 7 spaced apart from each other. The two gaskets 7 are sleeved to the rotary shaft 31, and fixed at two ends of the steel magnet 32 respectively. This facilitates improved fixation of the steel magnet 32 and the rotary shaft 31.

In some embodiments, the shell 1 includes a first cover plate 11 and a second cover plate 12 disposed opposite to each other. The first cover plate 11 and the second cover plate 12 are respectively fixed to respective two ends of two housings 21, and two ends of the rotary shaft 31 are rotationally connected to the first cover plate 11 and the second cover plate 22, respectively.

In some embodiments, the stepper motor 100 further includes a first bearing 8 and a second bearing 9. The first bearing 8 is sleeved to an end of the rotary shaft 31 adjacent to the first cover plate 11, and embedded into and fixed to the first cover plate 11. The second bearing 9 is sleeved to an end of the rotary shaft 31 adjacent to the second cover plate 12, and embedded into and fixed to the second cover plate 12. The first bearing 8 and the second bearing 9 are sleeved and fixed to the rotary shaft 31, reducing the friction of rotation of the rotary shaft 31 and improving the rotation effect.

Compared with the existing art, in the stepper motor of the present disclosure, the stator assemblies are disposed around and spaced apart from the rotor assembly; the rotor assembly includes a rotary shaft, and a steel magnet sleeved and fixed to the rotary shaft, an end of the rotary shaft being rotationally connected to the shell; the plurality of stator assemblies are sleeved to the rotor assembly and arranged in an axial direction of the rotary shaft; and each stator assembly includes a housing coaxially disposed with and fixed to the shell, a fixation claw pole disposed around an outer periphery of the rotor assembly and received and fixed in the housing, and a winding sleeved to the fixation claw pole; the housing includes a housing body fixed to the shell, and an inclined structure portion formed by localized depression of an outer periphery of the housing body toward the rotor assembly; and the circuit board is affixed to the housing body on a side of the housing body facing away from the rotor assembly, an orthographic projection of the circuit board toward the rotor assembly at least partially falls into a confine of the inclined structure portion, the inclined structure portion is provided with an avoidance hole, and a lead of the winding extends out via the avoidance hole and is electrically connected to the circuit board. This facilitates direct attachment and fixation of the circuit board to the housing, and at the same time, saves the mounting space between the lead of the winding and the circuit board, reduces the width space of the stepper motor when stacked in the form of whole machine and facilitates miniaturized design.

The above are only embodiments of the present disclosure, and it should be noted that for a person of ordinary skill in the art, improvements may be made without departing from the concept of the present disclosure, all of which fall within the scope of protection of the present disclosure.

What is claimed is:

1. A stepper motor, comprising:
a shell;
a rotor assembly, supported on and rotationally connected to the shell; and
a plurality of stator assemblies, fixed to the shell, and disposed around and spaced apart from the rotor assembly;
wherein the rotor assembly includes a rotary shaft, and a steel magnet sleeved and fixed to the rotary shaft, an end of the rotary shaft being rotationally connected to the shell;
wherein the plurality of stator assemblies are sleeved to the rotor assembly and arranged in an axial direction of the rotary shaft, and each respective stator assembly of the plurality of stator assemblies includes:
a housing, coaxially disposed with and fixed to the shell, wherein the housing includes a housing body fixed to the shell, and an inclined structure portion formed by localized depression of an outer periphery of the housing body toward the rotor assembly;
a fixation claw pole, disposed around an outer periphery of the rotor assembly, and received and fixed in the housing; and
a winding, sleeved to the fixation claw pole;
wherein the stepper motor further comprises a circuit board affixed to the housing body on a side of the housing body facing away from the rotor assembly, an orthographic projection of the circuit board toward the rotor assembly at least partially falls into a confine of the inclined structure portion, the inclined structure portion is provided with an avoidance hole, and a lead of the winding extends out via the avoidance hole and is electrically connected to the circuit board.

2. The stepper motor according to claim 1, wherein the circuit board includes a circuit board body, and a pad portion formed by bending and extending at least one side of the circuit board body, wherein the circuit board body is affixed to the housing, and an orthographic projection of the pad portion toward the rotor assembly at least partially falls into the confine of the inclined structure portion.

3. The stepper motor according to claim 2, wherein the housing includes a housing bottom fixed to the shell, and a housing sidewall bending and extending from an outer periphery of the housing bottom;
wherein the housing bottom includes:
an arcuate side;
two parallel sides, extending from two ends of the arcuate side respectively;
a first straight side, positioned opposite to the arcuate side and spaced apart from the two the parallel sides; and
a second straight side and a third straight side, bending and extending from two ends of the first straight side to the two parallel sides respectively;
wherein the housing sidewall includes:
a first arcuate sidewall, extending from the arcuate side in the axial direction of the rotary shaft;
two parallel sidewalls, extending from the two parallel sides in the axial direction of the rotary shaft; and
a first sidewall, a second sidewall and a third sidewall, extending from the first straight side, the second straight side and the third straight side in the axial direction of the rotary shaft respectively, wherein the circuit board body is affixed to the first sidewall, and the second sidewall and the third sidewall serve as two inclined structure portions.

4. The stepper motor according to claim 2, wherein the lead of the winding is fixed to the pad portion by gluing on a side of the pad portion facing away the rotor assembly.

5. The stepper motor according to claim 1, wherein the fixation claw pole includes a first law pole and a second law pole fixed opposite to each other in the housing and cooperating with each other, and the winding is sleeved and fixed to the first law pole and the second law pole.

6. The stepper motor according to claim 1, wherein the stepper motor further comprises a magnetic isolation spacer, wherein the magnetic isolation spacer is of an annular structure, and sleeved and fixed to the fixation claw pole, and the winding is sleeved and fixed to the magnetic isolation spacer.

7. The stepper motor according to claim 1, wherein the stepper motor further comprises two gaskets spaced apart from each other, wherein the two gaskets are sleeved to the rotary shaft, and fixed at two ends of the steel magnet respectively.

8. The stepper motor according to claim 1, wherein the shell includes a first cover plate and a second cover plate disposed opposite to each other, the first cover plate and the second cover plate are fixed to respective two ends of housings of respective two stator assemblies of the plurality of stator assemblies, and two ends of the rotary shaft are rotationally connected to the first cover plate and the second cover plate respectively.

9. The stepper motor according to claim 8, wherein the stepper motor further comprises:
a first bearing, sleeved to an end of the rotary shaft adjacent to the first cover plate, and embedded into and fixed to the first cover plate; and
a second bearing, sleeved to an end of the rotary shaft adjacent to the second cover plate, and embedded into and fixed to the second cover plate.
